(19) United States
(12) Patent Application Publication
(10) Pub. No.: US 2024/0289456 A1
(43) Pub. Date: Aug. 29, 2024

(54) NEURAL NETWORK SYSTEMS WITH PROTECTION LOGIC AND OPERATION METHODS THEREOF

(71) Applicant: Samsung Electronics Co., Ltd., Suwon-si, Gyeonggi-do (KR)

(72) Inventors: Insup Kim, Suwon-si (KR); Ganggyu Lee, Suwon-si (KR)

(21) Appl. No.: 18/239,319

(22) Filed: Aug. 29, 2023

(30) Foreign Application Priority Data
Feb. 28, 2023 (KR) 10-2023-0026674

(51) Int. Cl. G06F 21/56; G06N 3/04

(52) U.S. Cl. CPC G06F 21/566; G06N 3/04; G06F 2221/034

(57) ABSTRACT

A deep neural network system, comprising, a neural network operation unit configured to perform a convolution operation on input features to generate a classification result, a memory unit configured to store a trained neural network model in a first storage and configured to perform a first parameter to the neural network operation unit based on the trained neural network model, an attack detection circuit configured to generate a trigger signal periodically or when a hostile attack on the memory unit is detected, and a protection logic unit configured to detect whether or not the first parameter provided to the neural network driver in the memory unit has been tampered with in response to the trigger signal, and provide a second parameter to the neural network operation unit using the trained neural network model backed up in a second storage according to the detection result.

### CROSS-REFERENCE TO RELATED APPLICATIONS

This application claims priority under 35 U.S.C. § 119 to Korean Patent Application No. 10-2023-0026674 filed on Feb. 28, 2023, in the Korean Intellectual Property Office, the disclosures of which are incorporated by reference herein in their entireties.

### TECHNICAL FIELD

Aspects of the present disclosure relate to semiconductor devices, and more particularly, to neural network systems having protection logic and operating methods thereof.

### BACKGROUND

A deep neural network (DNN) is an artificial neural network widely used in various machine learning systems. In particular, deep neural networks are applied actively in fields such as object recognition and environment recognition, and provide image processing capabilities. For example, recently, deep neural networks have been used in autonomous vehicle applications to provide autonomous driving data by processing images collected through a camera of an autonomous vehicle.

However, in recent years, concerns about adversarial attacks on artificial intelligence systems such as deep neural networks have increased. In particular, an adversarial attack on a memory or storage in which a trained neural network model is stored may significantly reduce an object recognition rate of an autonomous vehicle. A deterioration in the recognition rate of neural network models used in systems such as autonomous vehicles may lead to incorrect recognition of facilities, pedestrians, and traffic signals on the road. Malfunctions of these deep neural networks greatly affect the safe operation of vehicles. Therefore, high security is viewed as a requirement to prevent or reduce occurrence of attacks on deep neural networks or artificial intelligence systems.

### SUMMARY

Embodiments of the present disclosure provides a deep neural network system with protection logic capable of protecting neural network parameters from hostile attacks.

According to some embodiments, a deep neural network system may include a neural network operation unit configured to perform a convolution operation on input features and generate a classification result, a memory unit configured to store a trained neural network model in a first storage and provide a first parameter to the neural network operation unit based on the trained neural network model, an attack detection circuit configured to generate a trigger signal periodically and/or when a hostile attack on the memory unit is detected, and a protection logic unit configured to detect whether or not the first parameter provided to the neural network driver in the memory unit has been tampered with in response to the trigger signal, and configured to provide a second parameter to the neural network operation unit according to the detection result, the second parameter backed up in a second storage.

According to some embodiments, an operation method of a deep neural network system may include backing up a trained neural network model stored in a first storage to a second storage, transferring data from the first storage to a cache memory to transfer a first parameter to a neural network operator, comparing the first parameter with a second parameter that is a backed-up value of the first parameter from the second storage, and updating the neural network operator with the second parameter when the first parameter and the second parameter do not match.

According to some embodiments, a deep neural network system configured to perform object recognition operations may include, a neural network operation unit configured to classify an input image through neural network operation, a first storage configured to store a trained neural network model, a cache memory configured to transfer the trained neural network model stored in the first storage to the neural network operator, a second storage configured to store the backed up trained neural network model, an attack detection circuit configured to generate a trigger signal upon detection of an adversarial attack against the first storage or the cache memory, and a comparator/updater configured to compare data in the cache memory with data in the second storage in response to the trigger signal and configured to update the neural network operator with the backed up trained neural network model according to the comparison result.

### BRIEF DESCRIPTION OF THE FIGURES

The above and other objects and features of the present disclosure will become apparent by describing in detail embodiments thereof with reference to the accompanying drawings.

FIG. 1 is a block diagram showing a neural network system according to some embodiments of the present inventive concepts.

FIG. 2 is a block diagram showing an embodiment of the components of FIG. 1.

FIG. 3 is a flowchart showing operations performed in the neural network system of FIG. 2.

FIG. 4 is a diagram visually showing a method for backing up a trained neural network model according to some embodiments of the present inventive concepts.

FIG. 5 is a block diagram showing configurations of a neural network system according to some embodiments of the present inventive concepts.

FIG. 6 is a flowchart showing operations performed in the neural network system of FIG. 5.

FIG. 7 is a diagram showing a method for backing up a trained neural network model according to some embodiments of the present inventive concepts.

FIG. 8 is a diagram showing a method for backing up a trained neural network model according to some embodiments of the present inventive concepts.

FIG. 9 is a graph showing an example of a method for analyzing vulnerability/sensitivity of a neural network model to bit-flip.

FIG. 10 is a block diagram showing configurations of a neural network system according to some embodiments of the present inventive concepts.

FIG. 11 is a flowchart showing operations performed in the neural network system of FIG. 10.

### DETAILED DESCRIPTION

It is to be understood that both the foregoing general description and the following detailed description provide only some examples of embodiments of the present inventive concepts, and it is to be considered that additional embodiments or implementations of the provided inventive concepts are within the skill of those in the art. Reference signs are indicated in detail in preferred embodiments of the present inventive concepts, examples of which are indicated in the reference drawings. Wherever possible, the same reference numbers are used in the description and drawings to refer to the same or like parts.

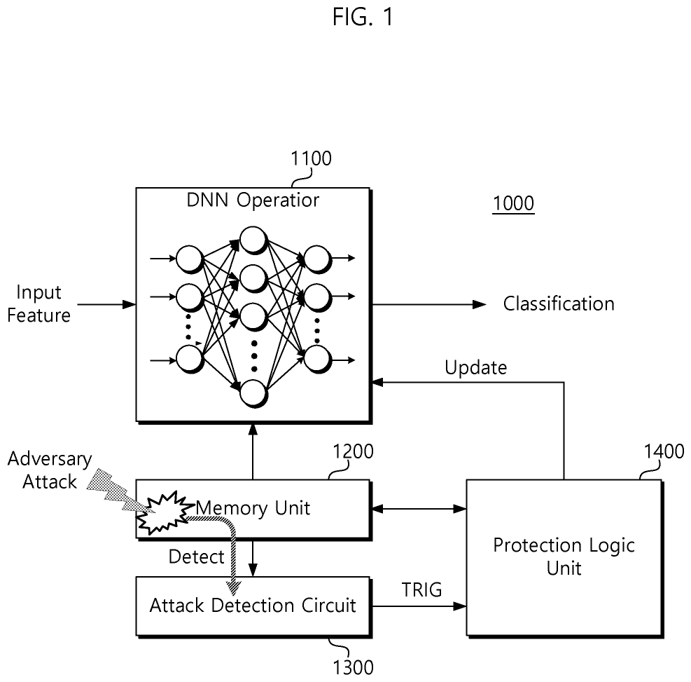

FIG. 1 is a block diagram showing a neural network system according to some embodiments of the present inventive concepts. Referring to FIG. 1, a neural network system 1000 may include a deep neural network operator 1100, a memory unit 1200, an attack detection circuit 1300, and a protection logic unit 1400. The neural network system 1000 may be part of an object recognition device included in a driving management system of an autonomous vehicle, a smart phone, or various home appliances, as non-limiting examples.

The deep neural network operator 1100 may process an input feature input in real time by applying a deep neural network operation. The deep neural network operator 1100 may generate a classification value for an input feature as a result of deep neural network operation. For example, when the deep neural network operation is a convolution operation, the deep neural network operator 1100 may include multiplier-accumulator (MAC) cores for performing a plurality of multiplier-accumulator MAC operations. The MAC cores may process multiple convolution operations in parallel. That is, The MAC cores may generate classification values for an input feature, which may be generated by parallel processing a convolution operation between input features and a kernel. In order to configure the deep neural network operator 1100, a neural network structure (e.g., coordinate) and neural network parameters (e.g., weight or bias) may be used. The neural network structure and parameters may be provided from the memory unit 1200.

The memory unit 1200 may store and may provide the neural network structure and parameters to the deep neural network operator 1100. The memory unit 1200 may store information about the neural network structure (e.g., coordinate) in storage. The memory unit 1200 may store the neural network parameters, such as the weights or biases, of the neural network on which learning has been completed in storage. Also, the memory unit 1200 may periodically or when needed provide the neural network coordinates, weights, and biases of the neural network to the deep neural network operator 1100. The deep neural network operator 1100 may process input features after setting the structure, weights, and biases of the deep neural network based on the delivered neural network structure.

In particular, the memory unit 1200 may include a storage for storing a neural network structure (e.g., coordinate), weight or bias. Also, the memory unit 1200 may include a cache memory or buffer that supplies parameters (e.g., needed parameters) when operations such as convolution operation, bias addition, activation (ReLU), and/or pooling are performed in the deep neural network operation unit 1100.

An adversary attack on the memory unit 1200 may be a row-hammering attack on DRAM used as a cache memory. A bit-flip may occur in a neural network coordinate, weight, or bias stored in a cache memory due to a row-hammering attack. Similarly, an uncorrectable error may occur in a flash memory used as storage due to an adversarial attack on storage.

The attack detection circuit 1300 may monitor and may detect a hostile attack on the memory unit 1200. The attack detection circuit 1300 may detect a row-hammering attack on the cache memory of the memory unit 1200. For example, the attack detection circuit 1300 may detect a row-hammering attack on a specific row or memory area by monitoring an access address to a DRAM included in a cache memory. A bit-flip may occur from a row-hammering attack in a neural network coordinate, weight, or bias stored in a cache memory. Similarly, a correctable error or an uncorrectable error may occur in a flash memory used as storage due to an adversarial attack on storage. An error detection/correction code that uses a checksum to detect the occurrence of an error can be used.

In some embodiments, in order to detect an adversarial attack on the memory unit 1200, the attack detection circuit 1300 may include a pattern anomaly detection logic that applies a machine learning technique. The pattern abnormality detection logic may detect an irregularity in an access pattern to the cache memory or storage of the memory unit 1200. For example, the pattern anomaly detection logic may determine an anomaly of an access pattern to the memory unit 1200 using unsupervised machine learning, which may be one of clustering techniques. If the pattern anomaly detection logic determines that the access pattern to the memory unit 1200 is irregular, it may recognize it as a hostile attack.

When it is determined that a hostile attack has occurred, the attack detection circuit 1300 may generate a trigger signal TRIG for activating the function of the protection logic unit 1400. In some embodiments, activation of the trigger signal TRIG may occur not only when an adversarial attack is detected, but also periodically or at the request of a user or controller logic.

The hostile attack monitoring function of the attack detection circuit 1300 is not limited to row-hammering attacks. The attack detection circuit 1300 may monitor various security attacks that attempt to falsify or extort data stored in the memory unit 1200. For example, the attack detection circuit 1300 may monitor various hacking attacks, such as RAMBleed, cold boot attack, and cross-CPU attack, as non-limiting examples.

The protection logic unit 1400 may determine whether the data of the memory unit 1200 has been tampered with in response to the trigger signal TRIG of the attack detection circuit 1300. According to the determination result, the protection logic unit 1400 may provide at least one of the neural network coordinate, the neural network weight, and/or the bias to the deep neural network operator 1100 instead of the memory unit 1200.

In particular, the protection logic unit 1400 may separate and back up parameters that are vulnerable or sensitive to attacks from among parameters such as a neural network structure (e.g., coordinate), a neural network weight, and a bias. Also, the protection logic unit 1400 may update the parameters of the deep neural network operator 1100 with the backed-up parameters in response to the trigger signal TRIG. The protection logic unit 1400 may increase the security performance of the backed-up parameters by applying encryption.

A simple structure of the neural network system 1000 of the present inventive concepts has been described as above. The protection logic unit 1400 of the present inventive concepts may back up the learned neural network parameters to a separately provided storage. In this case, the data to be backed up may be all or part of the learned neural network parameters. In the case of backing up some of the neural network parameters, the protection logic unit 1400 may separate and back up parameters that are vulnerable or sensitive to attacks. Backup of neural network parameters may include security enhancement procedures using encryption. Applying the aforementioned neural network parameter backup and update method, the neural network system 1000 can be protected from bit-flips or uncorrectable errors caused by various adversarial attacks.

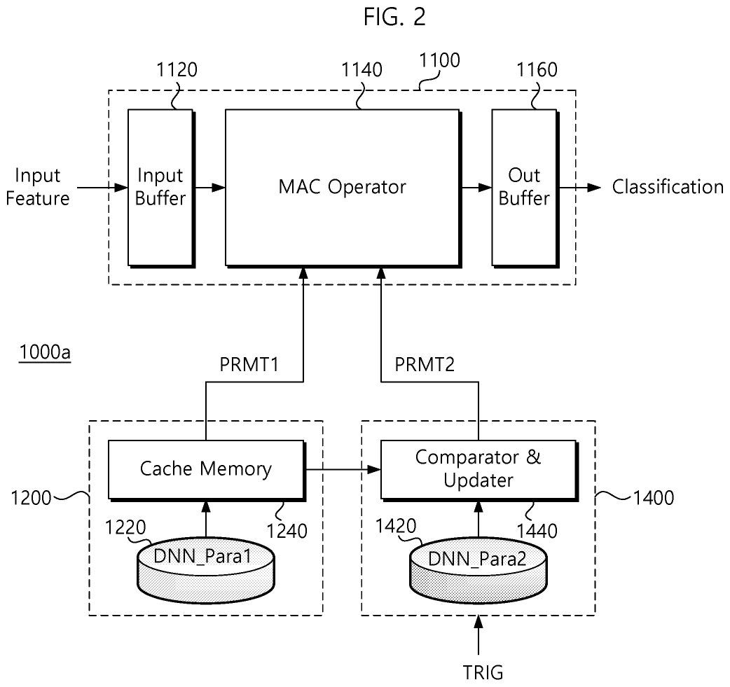

FIG. 2 is a block diagram showing an embodiment of the configurations of FIG. 1. Referring to FIG. 2, a neural network system 1000a according to some embodiments includes a deep neural network operator 1100, a memory unit 1200, and a protection logic unit 1400. Since the attack detection circuit 1300 is a function of providing a trigger signal TRIG, illustration is omitted in this drawing.

The deep neural network operator 1100 can be implemented as hardware or software. Features of the present inventive concepts will be described based on the deep neural network operator 1100 being implemented in hardware in the presently described embodiments. However, even when the deep neural network operator 1100 is implemented as software, the present inventive concepts can be equally applied. The deep neural network operator 1100 may include an input buffer 1120, a MAC calculator 1140, and an output buffer 1160. The deep neural network operator 1100 having the above-described configuration may be implemented using processors such as FPGAs, GPUs, and NPUs, as examples.

Data values of input features may be loaded into the input buffer 1120. The size of the input buffer 1120 may vary according to the size of a kernel for convolution operation. For example, when the size of the kernel is K×K, the input buffer 1120 must be loaded with input data having a size sufficient to enable sequential performance of a convolution operation with the kernel by the MAC operator 1140. The input buffer 1120 may be defined as a buffer size for storing input features.

The MAC operator 1140 may perform a convolution operation using the input buffer 1120 and the output buffer 1160. The MAC operator 1140 may process, for example, multiplication and accumulation of input features with a kernel. The MAC operator 1140 may include a plurality of MAC cores for processing a plurality of convolution operations in parallel. The MAC operator 1140 may process in parallel a convolution operation between a kernel provided from the memory unit 1200 and an input feature piece stored in the input buffer 1120.

The output buffer 1160 may be loaded with result values of the convolution operation or pooling performed by the MAC operator 1140. The result value loaded into the output buffer 1160 may be updated according to the execution result of each convolution loop by the plurality of kernels. Output buffer 1160 may be sized to store output features of MAC operator 1140.

The memory unit 1200 may provide structures or parameters of a deep neural network executed in the deep neural network operator 1100. The memory unit 1200 may store the already learned deep neural network structure and parameters in the first storage 1220. The deep neural network related parameters stored in a first storage 1220 will be referred to as a first neural network parameter DNN_Para1.

The memory unit 1200 may supply the deep neural network structure and parameters to the deep neural network operator 1100 through the cache memory 1240. For example, the memory unit 1200 may set the deep neural network operator 1100 by providing information on a coordinate defining basic characteristics of the deep neural network operator 1100. Also, the memory unit 1200 may provide parameters used in a convolution operation, bias addition, activation (ReLU), and/or pooling performed by the MAC operator 1140 of the deep neural network operator 1100. A parameter provided to the deep neural network operator 1100 by the cache memory 1240 of the memory unit 1200 will be referred to as a first parameter PRMT1.

If an adversarial attack occurs, errors or bit-flips may occur in data stored in the first storage 1220 or the cache memory 1240. That is, modulation may occur in the first neural network parameter DNN_Para1 stored in the first storage 1220 due to an adversarial attack. Alternatively, a bit-flip may occur in stored data by an attack such as row-hammering on the cache memory 1240. Then, the first parameter PRMT1 transmitted to the deep neural network operator 1100 may include an error, and the normal operation of the deep neural network operator 1100 may be disturbed. When a hostile attack is detected, the trigger signal TRIG may be activated by the attack detection circuit 1300 described above, and the protection logic unit 1400 may be activated.

The protection logic unit 1400 may execute a defense operation to correct a bit-flip or error of the memory unit 1200 in response to a trigger signal TRIG generated as a result of detecting a hostile attack. To this end, the protection logic unit 1400 may include a second storage 1420 and a comparator/updater unit 1440. The second storage 1420 may store the structure of the deep neural network that has been trained and may store various operating parameters. Parameters related to the deep neural network stored in the second storage 1420 are referred to as second neural network parameters (DNN_Para2). That is, a portion or all of the neural network model information driven by the deep neural network operator 1100 may be stored. Accordingly, in an initial state, the first neural network parameter DNN_Para1 and the second neural network parameter DNN_Para2 stored in the first storage 1220 of the memory unit 1200 may be the same data.

When the trigger signal TRIG is activated, the comparator/updater unit 1440 may compare data of the cache memory 1240 with data obtained from the backed-up second neural network parameter DNN_Para2. If the parameters of the cache memory 1240 and the backed up parameters do not match, the comparator/updater unit 1440 may transmit the backed up second parameter PRMT2 to the deep neural network operator 1100. Then, the weight or bias or structure information of the deep neural network operator 1100 will be updated based on the backed-up second parameter PRMT2. Further, the deep neural network operator 1100 will perform neural network calculation based on the updated parameters from which errors have been removed.

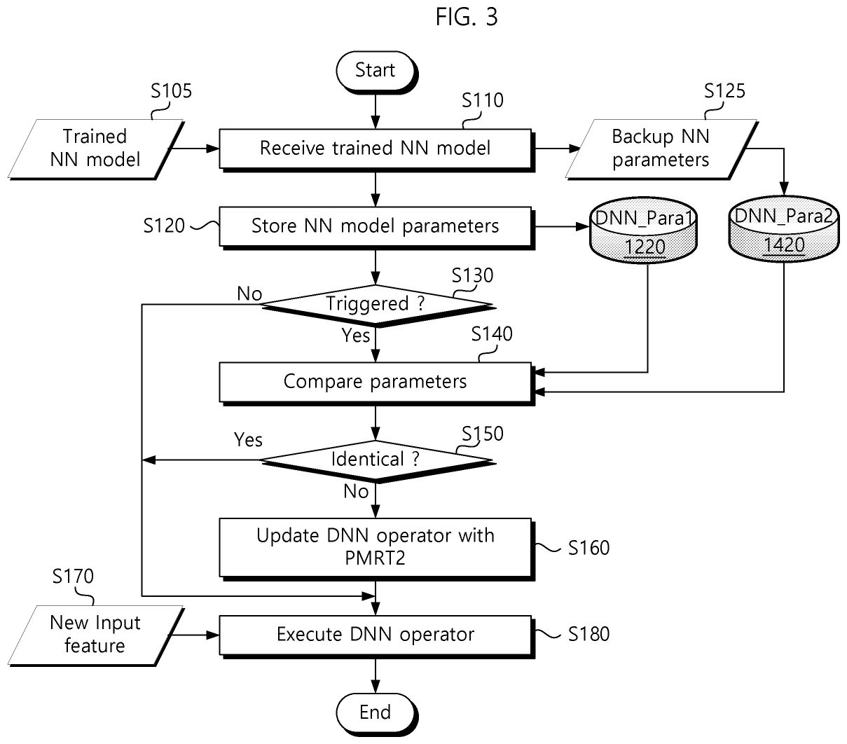

FIG. 3 is a flowchart showing operations performed in the neural network system of FIG. 2. Referring to FIG. 3, the neural network system 1000a may update the parameters of the neural network model using the backed up parameters when there is an error in the parameters stored in the memory unit 1200.

In operation S105, a trained neural network model may be provided. The trained neural network model may be a specialized neural network model in various fields such as object recognition or pattern recognition.

In operation S110, the neural network system 1000a may receive the input neural network model. That is, the neural network system 1000a may receive various parameters of the trained neural network model.

In operation S120, the neural network system 1000a may store various parameters of the trained neural network model in the first storage 1220 of the memory unit 1200. At this time, the first neural network parameter DNN_Para1 stored in the first storage 1220 may be transmitted to the deep neural network operator 1100 via the cache memory 1240.

In operation S125, the neural network system 1000a may back up parameters (e.g., all parameters) of the trained neural network model to the second storage 1420 of the protection logic unit 1400. Upon completion of operation S125, the second neural network parameter DNN_Para2 backed up in the second storage 1420 may be provided to the comparator/updater unit 1440 upon activation of the trigger signal TRIG.

In operation S130, the attack detection circuit 1300 may determine whether the trigger signal TRIG is activated. The attack detection circuit 1300 may monitor a hostile attack on the memory unit 1200. For example, the attack detection circuit 1300 may monitor whether a row-hammering attack on the cache memory 1240 or an uncorrectable error in the first storage 1220 has occurred. When a hostile attack is detected, the attack detection circuit 1300 may activate the trigger signal TRIG. Alternatively, activation of the trigger signal TRIG may be set to occur at predetermined intervals (e.g., occur repeatedly) as well as at detection of a hostile attack. If the trigger signal TRIG is activated (‘Yes’ direction from operation S130), the procedure moves to operation S140. On the other hand, if the trigger signal TRIG is not activated (‘No’ direction from operation S130), the procedure moves to operation S180.

In operation S140, the comparator/updater unit 1440 of the protection logic unit 1400 may compare the first parameter PRMT1 cached in the cache memory 1240 and the second parameter PRMT2 that is backed up from the second storage 1420.

In operation S150, if the first parameter PRMT1 and the second parameter PRMT2 are the same (‘Yes’ direction from operation S150), the procedure moves to operation S180. On the other hand, when the first parameter PRMT1 and the second parameter PRMT2 are not the same (‘No’ direction from operation S150), the procedure moves to operation S160.

In operation S160, the protection logic unit 1400 may update the parameter of the deep neural network operator 1100 to the second parameter PRMT2. The second parameter PRMT2 may be parameter data supplied based on the second neural network parameter DNN_Para2 backed up in the protection logic unit 1400.

In operation S170, a new input feature to be processed by the deep neural network operator 1100 may be inputted. Then, in operation S180, the deep neural network operator 1100 may perform deep neural network calculation on the input feature and output the result.

In the above, some operation of the neural network system according to some embodiments of the present inventive concepts has been briefly described. When there is an error in the parameters stored in the memory unit 1200, the neural network system 1000a may update the parameters of the neural network model using the backed-up parameters. Therefore, even when a hostile attack on the memory unit 1200 has occurred, the neural network system 1000a can perform highly reliable neural network operations.

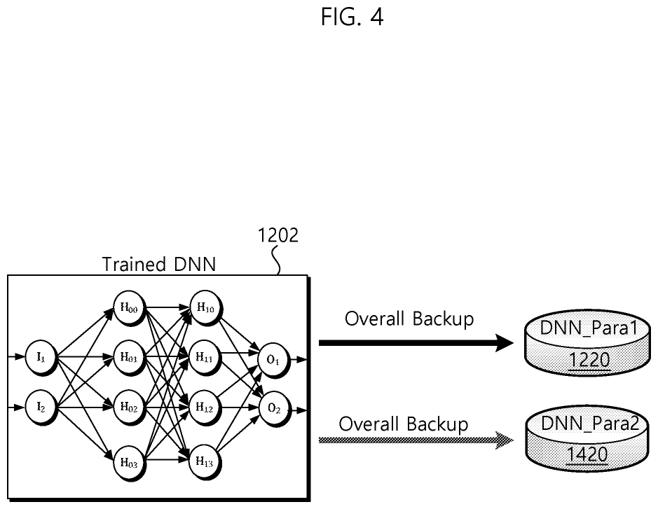

FIG. 4 is a diagram visually showing a method for backing up a trained neural network model according to some embodiments of the present inventive concepts. Referring to FIG. 4, parameters (e.g., all parameters) defining the trained neural network model 1202 may be backed up in the first storage 1220 and the second storage 1420, e.g., without omission.

The neural network system 1000a may store the trained parameters of the neural network model 1202 in the first storage 1220 of the memory unit 1200. The first neural network parameter DNN_Para1 stored in the first storage 1220 may be later used to set the deep neural network structure and parameters in the deep neural network operator 1100 through the cache memory 1240.

In addition, the neural network system 1000a may back up the trained parameters of the neural network model 1202 to the second storage 1420 of the protection logic unit 1400 without omission. The second neural network parameter DNN_Para2 stored in the second storage 1420 may be later provided to the comparator/updater unit 1440 and may be used to detect whether or not data in the cache memory 1240 has been tampered with. If data modulation is detected in the data of the cache memory 1240, the second neural network parameter DNN_Para2 stored in the second storage 1420 may be used to update the deep neural network structure and parameters in the deep neural network operator 1100.

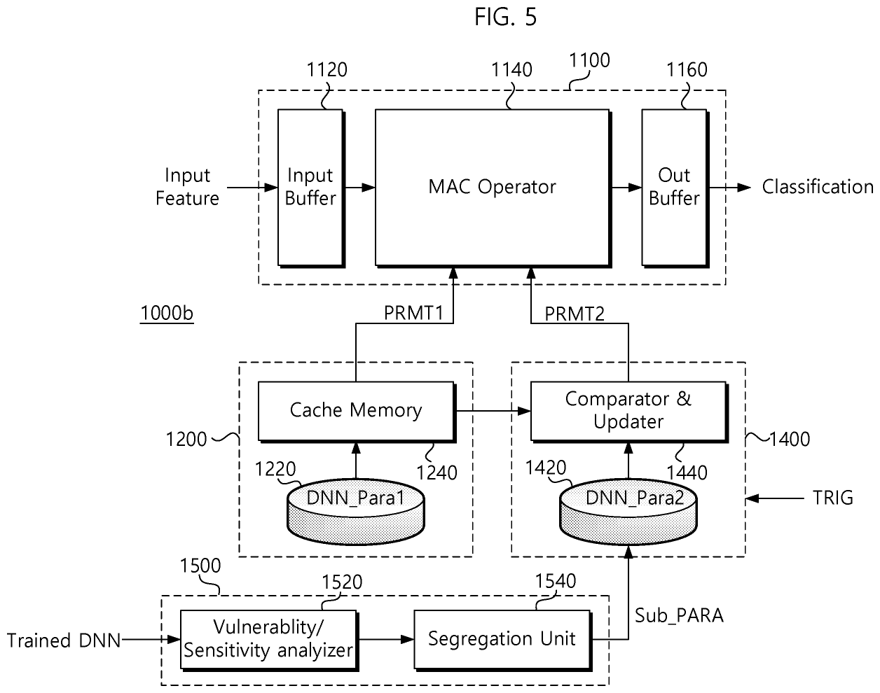

FIG. 5 is a block diagram showing configurations of a neural network system according to some embodiments of the present inventive concepts. Referring to FIG. 5, a neural network system 1000b according to some embodiments may include a deep neural network operator 1100, a memory unit 1200, a protection logic unit 1400, and a backup management unit 1500. The backup management unit 1500 may back up some parameters (e.g., fewer than all parameters), with the backed up parameters selected from deep neural network parameters in order to save backup space and/or reduce performance degradation that may occur in a parameter comparison operation. Here, since the deep neural network operator 1100 is substantially the same as that of FIG. 2, a description thereof will be omitted.

The memory unit 1200 may provide structures or parameters of the deep neural network driven by the deep neural network operator 1100. The memory unit 1200 may store the previously trained deep neural network structure and parameters in the first storage 1220 as the first neural network parameter DNN_Para1. The memory unit 1200 may supply the deep neural network structure and parameters such as weights and biases to the deep neural network operator 1100 through the cache memory 1240. A parameter provided from the memory unit 1200 to the deep neural network operator 1100 will be referred to as a first parameter PRMT1.

If an adversarial attack occurs, errors or bit-flips may occur in data stored in the first storage 1220 or the cache memory 1240. That is, modulation may occur in the first neural network parameter DNN_Para1 stored in the first storage 1220 due to an adversarial attack. Alternatively, a bit-flip may occur in stored data by an attack such as row-hammering on the cache memory 1240. Then, the first parameter PRMT1 transmitted to the deep neural network operator 1100 may include an error, and the normal operation of the deep neural network operator 1100 may be disturbed. When the adversarial attack is detected, the trigger signal TRIG may be activated by the attack detection circuit 1300 described above, and the protection logic unit 1400 may be activated.

The protection logic unit 1400 may execute a defense operation to correct a bit-flip or error of the memory unit 1200 in response to a trigger signal TRIG generated as a result of detecting a hostile attack. To this end, the protection logic unit 1400 may include a second storage 1420 and a comparator/updater unit 1440. In the second storage 1420, only parameters sensitive to and/or vulnerable to hostile attacks among parameters of the deep neural network that have been trained may be selectively backed up. Accordingly, the second neural network parameter DNN_Para2 stored in the second storage 1420 may be some parameters Sub_PARA selected from parameters of the deep neural network for which training has been completed. Therefore, in the initial state, the first neural network parameter DNN_Para1 and the second neural network parameter DNN_Para2 stored in the first storage 1220 of the memory unit 1200 are not the same. That is, the second neural network parameter DNN_Para2 may be the same as a subset or part of the first neural network parameter DNN_Para1.

When the trigger signal TRIG is activated, the comparator/updater unit 1440 may compare data of the cache memory 1240 with data obtained from the backed-up second neural network parameter DNN_Para2. If the parameters of the cache memory 1240 and the backed up parameters do not match, the comparator/updater unit 1440 may transmit the backed up second parameter PRMT2 to the deep neural network operator 1100. Then, the weight or bias or structure information of the deep neural network operator 1100 will be updated based on the backed-up second parameter PRMT2. Further, the deep neural network operator 1100 will perform neural network calculation based on the updated parameters from which errors have been removed.

The backup management unit 1500 may select some parameters to be backed up from deep neural network parameters for which training has been completed. Also, the backup management unit 1500 may back up only the selected parameters Sub_PARA to the second storage 1420 as the second neural network parameter DNN_Para2. For this operation, the backup management unit 1500 may include a vulnerability/sensitivity analyzer 1520 and a segregation unit 1540.

The vulnerability/sensitivity analyzer 1520 may select only neural network layers or model information vulnerable to bit-flips and/or errors from among learned deep neural network parameters. For example, in the case of a neural network model for identifying road signs, when a bit-flip occurs in a specific layer, sign identification accuracy may be significantly lower than that of other layers. In this case, the vulnerability/sensitivity analyzer 1520 may designate parameters of the corresponding layer as vulnerability/sensitivity parameters.

In some embodiments, the vulnerability/sensitivity analyzer 1520 may use a two-step vulnerability/sensitivity parameter selection method to reduce the amount of computation. First, among the learned parameters of the deep neural network, a Most Vulnerable Bit (hereinafter referred to as MVB) search that identifies the degree of accuracy reduction according to the position of the bit may be applied. After the most vulnerable bit (MVB) is selected, a most vulnerable layer (hereinafter referred to as MVL) may be selected from among layers of the deep neural network for the selected most vulnerable bit MVB. Through the selection of vulnerable or sensitive parameters in the above two steps, it may be possible to reduce the amount of finally selected parameters, and in some instances it may be possible to reduce significantly the amount of such selected parameters.

In some embodiments, a user of the deep neural network may select a vulnerability/sensitivity parameter according to the effect of an attack. For example, in the case of an autonomous vehicle, higher vulnerability/sensitivity may be assigned to parameters of a deep neural network applied to a front camera among a plurality of cameras, where the front camera is highly related to safety and/or situational awareness. On the other hand, relatively low vulnerability/sensitivity may be assigned to deep neural network parameters processing data of a side camera of the plurality of cameras not related as closely to such safety and/or situational awareness.

The segregation unit 1540 may separate some parameters classified as parameters vulnerable/sensitive to errors and/or bit-flips from parameters of the neural network model. Also, the segregation unit 1540 may back up only the selected vulnerability/sensitivity parameter Sub_PARA to the second storage 1420. Accordingly, the second neural network parameter DNN_Para2 stored in the second storage 1420 may be some parameters Sub_PARA selected from parameters of the deep neural network for which learning has been completed.

In the above-described embodiments, when a technique of selectively backing up only vulnerability/sensitivity parameters is used, the amount of calculations generated according to parameter comparison may be reduced (e.g., significantly reduced). In addition, it is expected that the capacity or storage resources of the second storage 1420 used for parameter backup can be reduced.

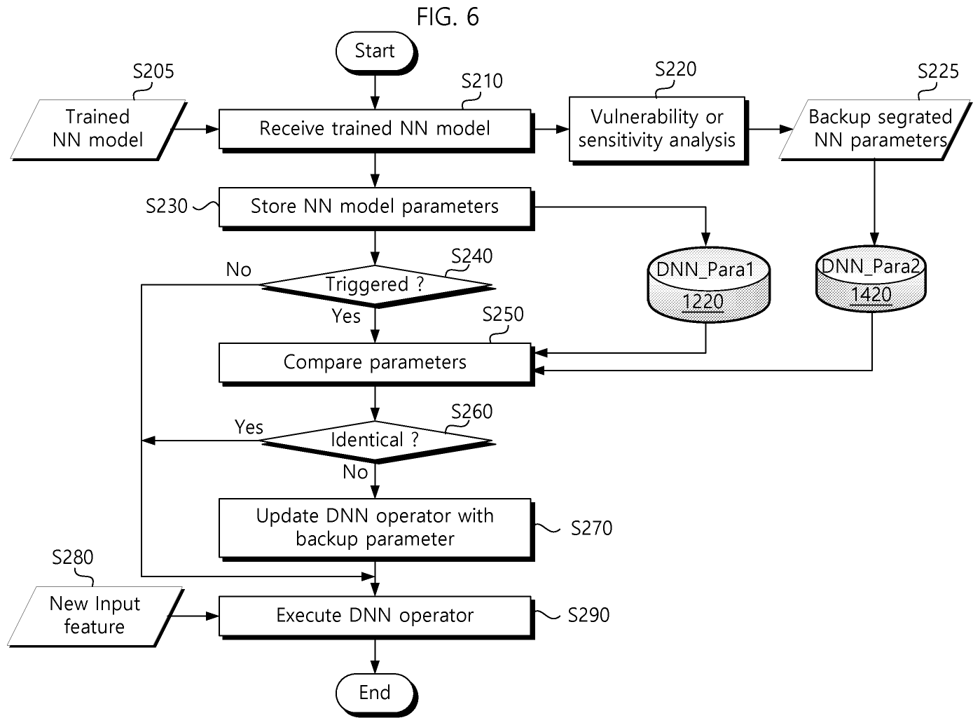

FIG. 6 is a flowchart showing operations performed in the neural network system of FIG. 5. Referring to FIG. 6, the neural network system 1000b may update the parameters of the neural network model using the backed up parameters when there is an error in the parameters stored in the memory unit 1200. At this time, the backed-up parameter may be data determined as a vulnerability/sensitivity parameter among the parameters of the neural network model. Therefore, the amount of calculations processed by the neural network system 1000b can be reduced, and the backup space can be used more efficiently.

In operation S205, a trained neural network model may be provided. The trained neural network model may be a specialized neural network model in various fields such as object recognition or pattern recognition.

In operation S210, the neural network system 1000b may receive the input neural network model. That is, the neural network system 1000b may receive various parameters of the trained neural network model.

In operation S220, parameters or neural network layers vulnerable to bit-flips and/or errors may be selected from parameters of the deep neural network learned by the vulnerability/sensitivity analyzer (see FIG. 5 1520). That is, when a bit-flip or an error occurs, information of a layer that has the greatest influence on a classification result output from the deep neural network operator 1100 may be detected through an analysis. The vulnerability/sensitivity analyzer 1520 may designate parameters of layers vulnerable to bit-flips and/or errors as the vulnerability/sensitivity parameters.

In operation S225, the segregation unit 1540 (see FIG. 5) of the neural network system 1000b may separate some parameters classified as vulnerability/sensitivity parameters from the neural network model. The segregation unit 1540 may back up only the selected vulnerability/sensitivity parameters Sub_PARA to the second storage 1420 (see FIG. 5).

In operation S230, the neural network system 1000b may store various parameters of the trained neural network model in the first storage 1220 of the memory unit 1200. At this time, the first neural network parameter DNN_Para1 stored in the first storage 1220 may be transmitted to the deep neural network operator 1100 via the cache memory 1240.

In operation S240, the attack detection circuit 1300 may determine whether the trigger signal TRIG is activated. For example, the attack detection circuit 1300 may monitor a hostile attack on the memory unit 1200. For example, the attack detection circuit 1300 may monitor whether a row-hammering attack on the cache memory 1240 and/or an uncorrectable error in the first storage 1220 has occurred. When a hostile attack is detected, the attack detection circuit 1300 may activate the trigger signal TRIG. Alternatively, activation of the trigger signal TRIG may be set to occur (e.g., repeatedly occur) at predetermined intervals as well as at detection of a hostile attack. If the trigger signal TRIG is activated (‘Yes’ direction from operation S240), the procedure moves to operation S250. On the other hand, if the trigger signal TRIG is not activated (‘No’ direction from operation S240), the process moves to operation S290.

In operation S250, the comparator/updater unit 1440 of the protection logic unit 1400 may compare the first parameter PRMT1 cached in the cache memory 1240 with the second parameter PRMT2 that is backed up from the second storage 1420. Here, the second parameter PRMT2 may be a vulnerability/sensitivity parameter backed up in the second storage 1420. Accordingly, the size of the second parameter PRMT2 may be significantly reduced, and resources used in comparison operation by the comparator/updater unit 1440 can be reduced and/or saved.

In operation S260, if the first parameter PRMT1 and the second parameter PRMT2 are the same (‘Yes’ direction from operation S260), the procedure moves to operation S290. On the other hand, when the first parameter PRMT1 and the second parameter PRMT2 are not the same (‘No’ direction from operation S260), the procedure moves to operation S270.

In operation S270, the protection logic unit 1400 may update the parameter of the deep neural network operator 1100 to the second parameter PRMT2. The second parameter PRMT2 may be a vulnerability/sensitivity parameter supplied based on the second neural network parameter DNN_Para2 backed up in the protection logic unit 1400.

In operation S280, a new input feature to be processed by the deep neural network operator 1100 may be inputted. In operation S290 that follows, the deep neural network operator 1100 may perform deep neural network calculation on an input feature and output the result.

In the above, some operation of the neural network system according to some embodiments of the present inventive concepts has been briefly described. When there is an error in the parameters stored in the memory unit 1200, the neural network system 1000b may update the parameters of the neural network model using the backed-up parameters. In particular, by using a technique of selectively backing up only vulnerability/sensitivity parameters, an amount of calculations generated according to parameter comparison can be reduced. In addition, a capacity of the second storage 1420 used parameter backup can be reduced and/or saved.

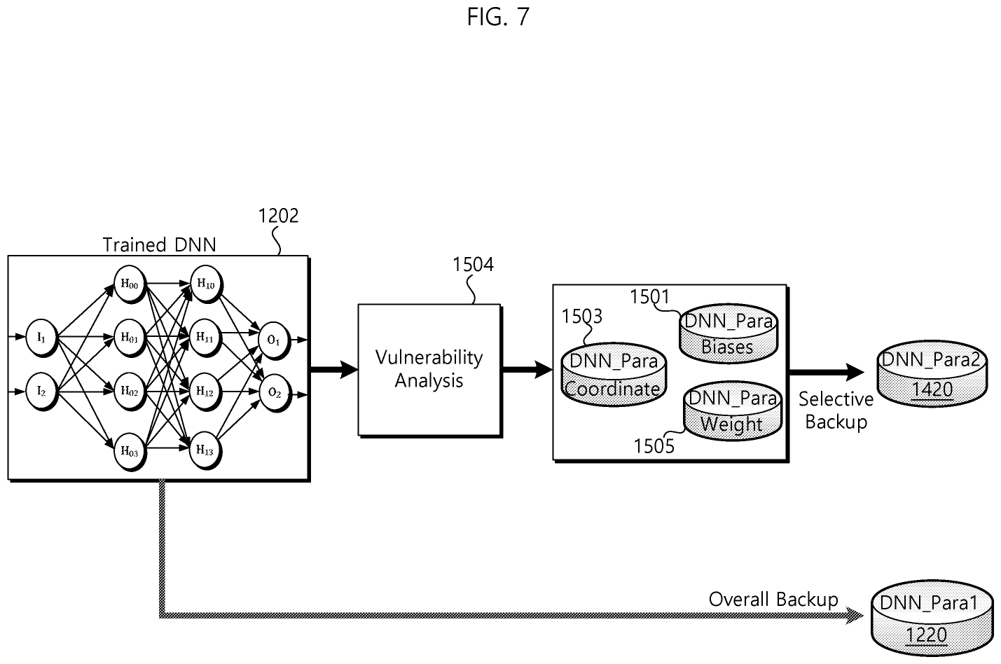

FIG. 7 is a diagram showing a method for backing up a trained neural network model according to some embodiments of the present inventive concepts. Referring to FIG. 7, parameters (e.g., all parameters) defining the trained neural network model 1202 may be stored in the first storage 1220 (see FIG. 5) without omission. On the other hand, only vulnerability parameters among the trained neural network model 1202 may be selectively backed up in the second storage 1420 (see FIG. 5).

The neural network system 1000b (see FIG. 5) may store the parameters of the trained neural network model 1202 in the first storage 1220 of the memory unit 1200 (see FIG. 5) without omission. The first neural network parameter DNN_Para1 stored in the first storage 1220 may be later used to set the deep neural network structure and parameters in the deep neural network operator 1100 through the cache memory 1240.

On the other hand, only parameters vulnerable to bit-flip may be backed up in the second storage 1420. The vulnerability/sensitivity analyzer (1520, see FIG. 5) may select only neural network layers or model information vulnerable to bit-flips and/or errors from among trained deep neural network parameters. For example, a deep neural network model trained through vulnerability analysis 1504 may be separated into a plurality of parameters. That is, parameters of the trained neural network model may be classified into a bias 1501, a structure 1503, and a weight 1505 according to vulnerabilities according to bit-flips. If the parameter most susceptible to bit-flip is the structure 1503 parameter, the structure 1503 parameter may be be backed up in the second storage 1420 as the second neural network parameter DNN_Para2.

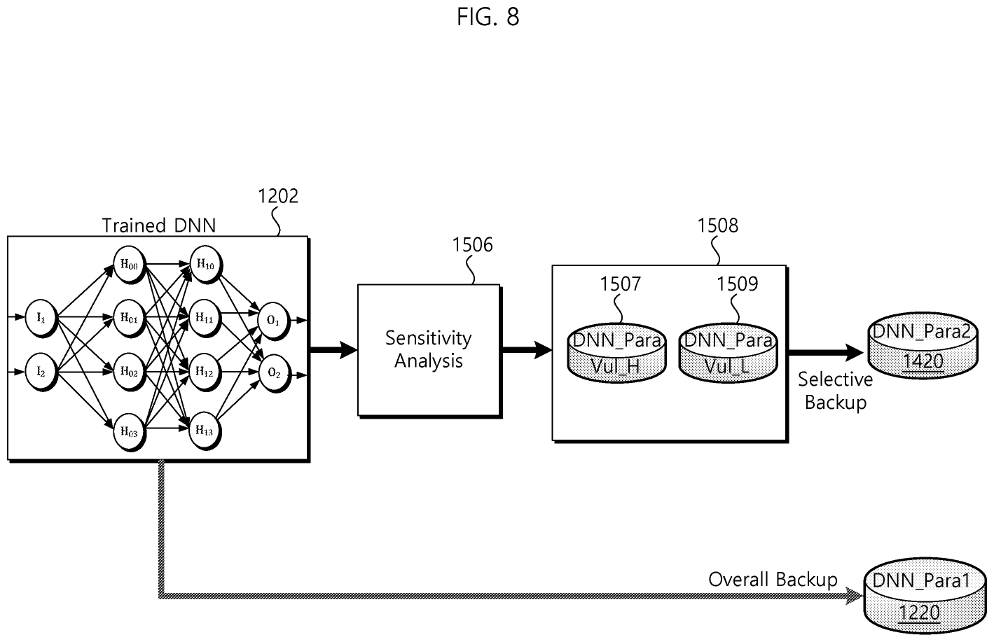

FIG. 8 is a diagram showing a method for backing up a trained neural network model according to some embodiments of the present inventive concepts. Referring to FIG. 8, parameters (e.g., all parameters) defining the trained neural network model 1202 may be stored in the first storage 1220 (see FIG. 5) without omission. On the other hand, in the second storage 1420 (refer to FIG. 5), only parameters vulnerable/sensitive to bit-flip among the trained neural network model 1202 may be selectively backed up.

The neural network system 1000b (see FIG. 5) may store the trained parameters of the neural network model 1202 in the first storage 1220 of the memory unit 1200 without omission. The first neural network parameter DNN_Para1 stored in the first storage 1220 may be later used to set the deep neural network structure and parameters in the deep neural network operator 1100 through the cache memory 1240.

On the other hand, only sensitive parameters are backed up in the second storage 1420. The vulnerability/sensitivity analyzer (1520, see FIG. 5) may select only neural network layers or parameters that are sensitive to bit-flips and/or errors from among learned deep neural network parameters. For example, a deep neural network model trained through vulnerability analysis 1504 may be separated into a plurality of parameters. That is, parameters of the trained neural network model may be classified based on vulnerability/sensitivity to e.g., a bit flip, and may be classified into e.g., a high vulnerability parameter 1507 with high vulnerability and a parameter 1509 with low vulnerability. For example, when a specific layer of the neural network is relatively vulnerable/sensitive, parameters constituting the corresponding layer may be classified as high vulnerability parameters 1507. Then, only the layer information classified as the high vulnerability parameter 1507 may be backed up in the second storage 1420 as the second neural network parameter DNN_Para2.

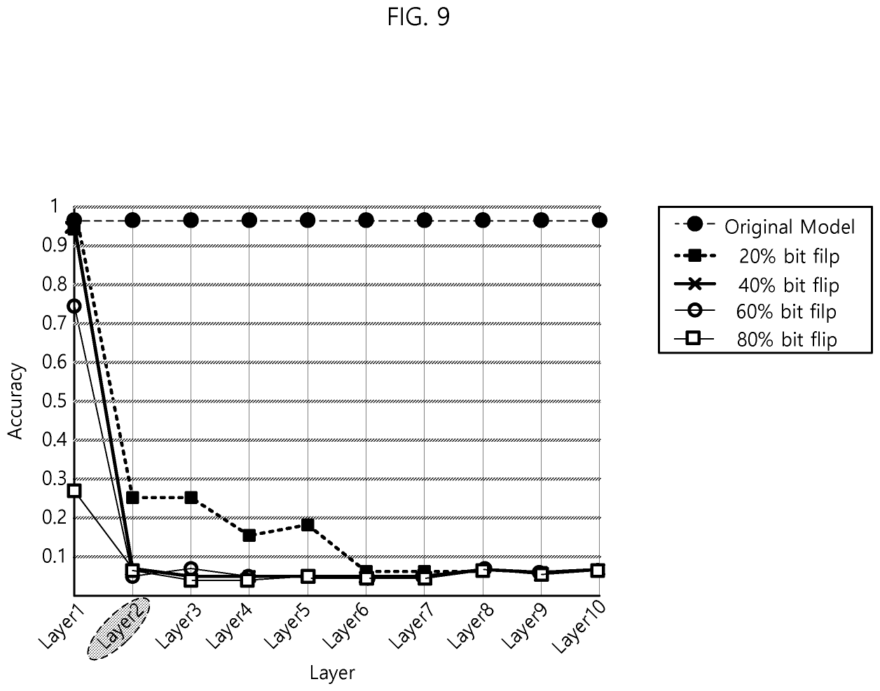

FIG. 9 is a graph showing an example of a method for analyzing vulnerability/sensitivity of a neural network model to bit-flip. Referring to FIG. 9, sensitivity to bit-flip of the trained neural network model may be analyzed for each layer.

For example, when a bit-flip occurs for each layer of a convolutional neural network model for road sign recognition, a decrease in accuracy of road sign recognition may be measured. In the case of the neural network model (original model) without any bit-flip, the recognition rate did not decrease. However, when the bit-flip is applied, the second layer (Layer2) appears to be the layer in which the degradation in the recognition rate is most remarkable. In this case, a parameter corresponding to the second layer (Layer2) may be selected as the vulnerability/sensitivity parameter. A parameter corresponding to the selected second layer (Layer2) may be backed up in the second storage 1420 as a second neural network parameter DNN_Para2.

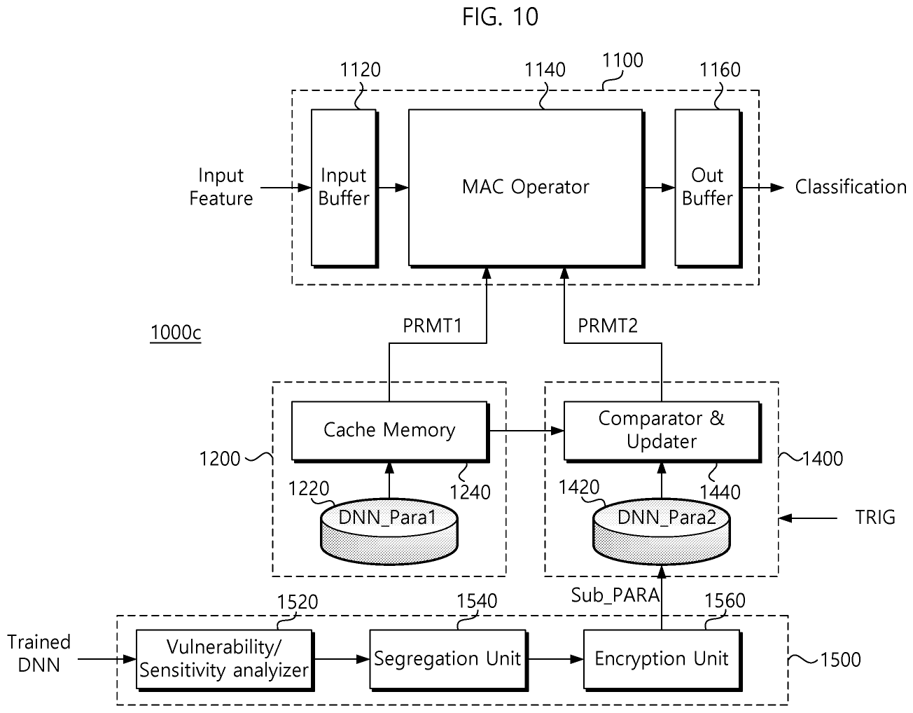

FIG. 10 is a block diagram showing configurations of a neural network system according to some embodiments of the present inventive concepts. Referring to FIG. 10, a neural network system 1000c according to some embodiments may include a deep neural network operator 1100, a memory unit 1200, a protection logic unit 1400, and a backup management unit 1600. In particular, the backup management unit 1600 may encrypt only selected parameters from deep neural network parameters and then may back up the encrypted parameters. Here, since the deep neural network operator 1100 and the memory unit 1200 are substantially the same as those of FIG. 2 or 5, description thereof will be omitted.

The protection logic unit 1400 may execute a defense operation to correct a bit-flip and/or error of the memory unit 1200 in response to a trigger signal TRIG that is generated as a result of detecting a hostile attack. To this end, the protection logic unit 1400 may include a second storage 1420 and a comparator/updater unit 1440. In the second storage 1420, among the parameters of the deep neural network that has been learned, parameters vulnerable/sensitive to hostile attacks may be encrypted and backed up. Accordingly, the second neural network parameter DNN_Para2 stored in the second storage 1420 may be data obtained by encrypting some parameters selected from the parameters of the deep neural network for which training has been completed.

When the trigger signal TRIG is activated, the comparator/updater unit 1440 may compare data of the cache memory 1240 with data obtained from the backed-up second neural network parameter DNN_Para2. At this time, the backed up second neural network parameter DNN_Para2 may be decrypted before being provided to the comparator/updater unit 1440. Accordingly, although not shown, the protection logic unit 1400 may further include a decoder for decoding the second neural network parameter DNN_Para2.

If the parameters of the cache memory 1240 and the backed up parameters do not match, the comparator/updater unit 1440 may transmit the backed up second parameter PRMT2 to the deep neural network operator 1100. Then, the weight or bias or structure information of the deep neural network operator 1100 may be updated based on the backed-up second parameter PRMT2. Further, the deep neural network operator 1100 may perform neural network calculation based on the updated parameters from which errors have been removed.

The backup management unit 1600 may select some parameters to be backed up from deep neural network parameters for which learning has been completed. The backup management unit 1600 may also encrypt the selected parameters. The backup management unit 1600 may back up the encrypted parameter to the second storage 1420 as a second neural network parameter DNN_Para2. For this operation, the backup manager 1600 may include a vulnerability/sensitivity analyzer 1620, a segregation unit 1640, and an encryption unit 1660. Since the vulnerability/sensitivity analyzer 1620 and the segregation unit 1640 may be identical to those of FIG. 5, descriptions thereof will be omitted.

The encryption unit 1660 may perform encryption on the vulnerability/sensitivity parameters selected by the segregation unit 1640. If encrypted in the encryption unit 1660, security performance for vulnerability/sensitivity parameters may be improved.

In the above-described embodiment, when a technique of encrypting only vulnerability/sensitivity parameters and selectively backing them up is used, the amount of calculations generated according to parameter comparison may be reduced. In addition, it is expected that the capacity of the second storage 1420 used in backing up the parameters can be reduced, and security performance for the backed up parameters may be improved.

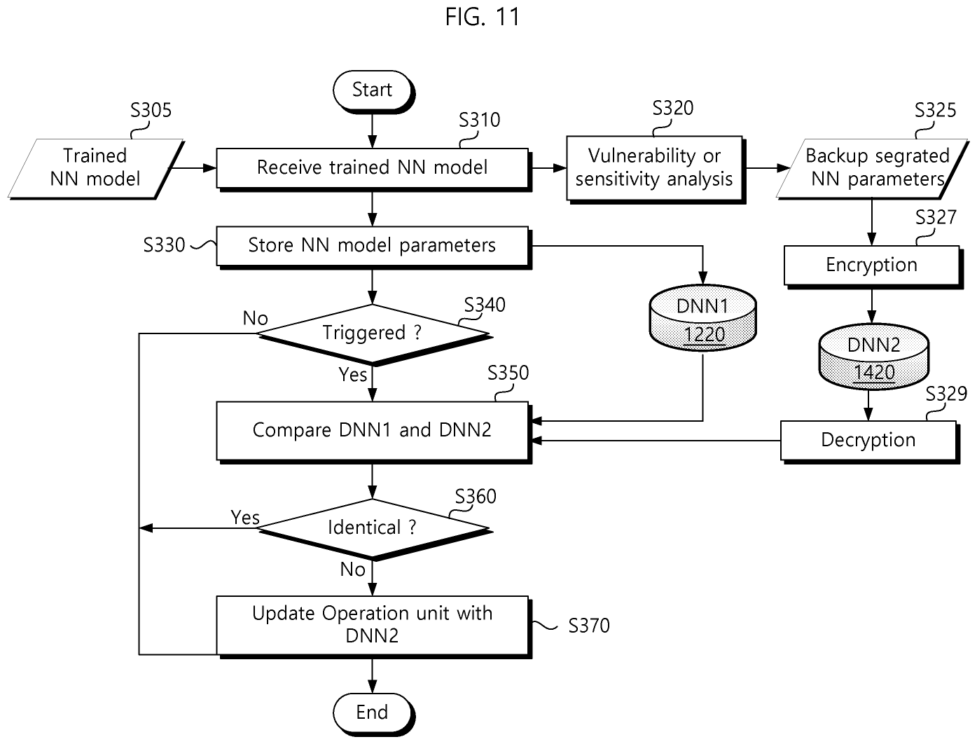

FIG. 11 is a flowchart showing operations performed in the neural network system of FIG. 10. Referring to FIG. 11, the neural network system 1000c may update the parameters of the neural network model using the backed up parameters when there is an error in the parameters stored in the memory unit 1200. At this time, the backed-up parameter may be encrypted data determined as a vulnerability/sensitivity parameter among the parameters of the neural network model. Accordingly, the amount of calculations processed by the neural network system 1000c may be reduced, security performance may be improved, and/or backup space may be used more efficiently.

In operation S305, a trained neural network model may be provided. The trained neural network model may be a specialized neural network model in various fields such as object recognition or pattern recognition.

In operation S310, the neural network system 1000c may receive the input neural network model. That is, the neural network system 1000c may receive various parameters of the trained neural network model.

In operation S320, neural network layers or model information vulnerable to bit-flips and/or errors may be selected from parameters of the deep neural network trained by the vulnerability/sensitivity analyzer (1620, see FIG. 10). That is, when a bit-flip or an error occurs, parameter information of a layer that has a relatively greatest influence on a classification result output from the deep neural network operator 1100 be detected through analysis. The vulnerability/sensitivity analyzer 1620 may designate parameters of layers vulnerable to bit-flips or errors by more than a reference value as vulnerability/sensitivity parameter.

In operation S325, the segregation unit 1640 (see FIG. 10) of the neural network system 1000c may separate some parameters classified as vulnerability/sensitivity parameters from the neural network model.

In operation S327, the encryption unit (1660, see FIG. 10) may encrypt the selected vulnerability/sensitivity parameters. The encrypted vulnerability/sensitivity parameters may be backed up to the second storage (1420, see FIG. 10).

In operation S329, the vulnerability/sensitivity parameters stored in the second storage 1420 after being encrypted may be decrypted. The decrypted vulnerability/sensitivity parameters may be provided to the comparator/updater unit 1440.

In operation S330, the neural network system 1000c may store various parameters of the trained neural network model in the first storage 1220 of the memory unit 1200. At this time, the first neural network parameter DNN_Para1 stored in the first storage 1220 may be transmitted to the deep neural network operator 1100 via the cache memory 1240.

In operation S340, the attack detection circuit 1300 may determine whether the trigger signal TRIG is activated. For example, the attack detection circuit 1300 may monitor a hostile attack on the memory unit 1200. For example, the attack detection circuit 1300 may monitor whether a row-hammering attack on the cache memory 1240 and/or an uncorrectable error in the first storage 1220 has occurred. When a hostile attack is detected, the attack detection circuit 1300 may activate the trigger signal TRIG. Alternatively, activation of the trigger signal TRIG may be set to occur (e.g., occur repeatedly) at predetermined intervals as well as at detection of a hostile attack. If the trigger signal TRIG is activated (‘Yes’ direction from operation S340), the procedure moves to operation S350. On the other hand, if the trigger signal TRIG is not activated (‘No’ direction from operation S340), the procedure moves to operation S390.

In operation S350, the comparator/updater unit 1440 of the protection logic unit 1400 may compare the first parameter PRMT1 cached in the cache memory 1240 with the second parameter PRMT2 that is backed up from the second storage 1420. Here, the second parameter PRMT2 may be a vulnerability/sensitivity parameter backed up in the second storage 1420. Accordingly, the size of the second parameter PRMT2 may be reduced (e.g., may be reduced significantly), and resources used in comparison operation by the comparator/updater unit 1440 may be reduced and/or saved.

In operation S360, if the first parameter PRMT1 and the second parameter PRMT2 are the same (‘Yes’ direction from operation S360), the procedure moves to operation S390. On the other hand, when the first parameter PRMT1 and the second parameter PRMT2 are not the same (‘No’ direction from operation S360), the procedure moves to operation S370.

In operation S370, the protection logic unit 1400 may update the parameter of the deep neural network operator 1100 to the second parameter PRMT2. The second parameter PRMT2 may be a vulnerability/sensitivity parameter supplied based on the second neural network parameter DNN_Para2 backed up in the protection logic unit 1400.

In operation S380, a new input feature to be processed by the deep neural network operator 1100 may be input. In operation S390 that follows, the deep neural network operator 1100 may perform deep neural network calculation on an input feature and output the result.

In the above, some operation of the neural network system according to some embodiments of the present inventive concepts has been briefly described. When there is an error in the parameters stored in the memory unit 1200, the neural network system 1000c may update the parameters of the neural network model using the backed-up parameters. In particular, by using a technique for encrypting and backing up vulnerability/sensitivity parameters, security performance for the parameters can be increased and/or the amount of calculations generated according to the comparison of the parameters may be reduced.

The above are specific embodiments for carrying out the present inventive concepts. In addition to the above-described embodiments, the present inventive concepts may include or encompass simple design changes or easily changeable embodiments. In addition, the present inventive concepts will include techniques that can be easily modified and implemented using the embodiments. Therefore, the scope of the present disclosure should not be limited to the above-described embodiments, and should be defined by the claims and equivalents of the claims of the present inventive concepts provided herein.

What is claimed is:

1. A deep neural network system, comprising:
a neural network operation unit configured to perform a convolution operation on input features and generate a classification result;
a memory unit configured to store a trained neural network model in a first storage and configured to provide a first parameter to the neural network operation unit based on the trained neural network model;
an attack detection circuit configured to generate a trigger signal periodically and/or when a hostile attack on the memory unit is detected; and
a protection logic unit configured to detect whether or not the first parameter provided to the neural network operation unit from the memory unit has been tampered with in response to the trigger signal, and configured to provide a second parameter to the neural network operation unit according to the detection result, the second parameter backed up in a second storage.

2. The system of claim 1, wherein the memory unit comprises a cache memory configured to transmit the trained neural network model stored in the first storage to the neural network operation unit.

3. The system of claim 2, wherein the attack detection circuit is configured to monitor at least one of a row-hammering attack on the cache memory, an error occurrence in the first storage, and/or an irregularity in an access pattern to the cache memory or the first storage.

4. The system of claim 2, wherein the protection logic unit comprises a comparator/updater unit that is configured to perform a comparison of the first parameter and the second parameter loaded in the cache memory.

5. The system of claim 4, wherein the comparator/updater unit is configured to transmit the second parameter instead of the first parameter to the neural network operation unit when the comparator/updater unit determines from the comparison that the first parameter is inconsistent with the second parameter.

6. The system of claim 1, further comprising:
a backup management unit configured to back up the trained neural network model to the second storage,
wherein the backup management unit comprises:
an analyzer configured to analyze parameters of the trained neural network model that are sensitive or vulnerable to bit-flips or errors; and
a segregation unit configured to separate vulnerable parameters or sensitive parameters from the trained neural network model according to a result of the analyzer and configured to back up the vulnerable parameters or the sensitive parameters up to the second storage.

7. The system of claim 6, wherein the backup management unit comprises an encryption unit configured to encrypt the vulnerable parameters or the sensitive parameters.

8. The system of claim 1, wherein the deep neural network system is included in an object recognition system of an autonomous vehicle.

9. An operation method of a deep neural network system, comprising:
backing up a trained neural network model stored in a first storage to a second storage;
transferring data from the first storage to a cache memory to transfer a first parameter to a neural network operator;
comparing the first parameter with a second parameter that is a backed-up value of the first parameter from the second storage; and
updating the neural network operator with the second parameter when the first parameter and the second parameter do not match.

10. The method of claim 9, further comprising:
comparing the first parameter with the second parameter in response to detecting an adversarial attack against the first storage or cache memory.

11. The method of claim 9, wherein the backing up of the trained neural network model to the second storage comprises:
classifying the trained neural network model into a plurality of parameter groups according to vulnerability or sensitivity to bit-flip; and
selecting at least one group from among the plurality of parameter groups and backing the selected at least one group up to the second storage.

12. The method of claim 11, wherein the plurality of parameter groups are divided into parameters corresponding to a structure, weight, bias, and layer of the trained neural network model.

13. The method of claim 11, further comprising:
encrypting the selected at least one group.

14. The method of claim 13, wherein the comparing the first parameter with the second parameter includes decoding the second parameter.

15. A deep neural network system configured to perform object recognition operations, comprising:
a neural network operation unit configured to classify an input image through neural network operation;
a first storage configured to store a trained neural network model;
a cache memory configured to transfer the trained neural network model stored in the first storage to the neural network operator;
a second storage configured to store a backed up trained neural network model;
an attack detection circuit configured to generate a trigger signal upon detection of an adversarial attack against the first storage or the cache memory; and
a comparator/updater configured to perform a comparison of data in the cache memory with data in the second storage in response to the trigger signal and configured to update the neural network operator with the backed up trained neural network model according to a result of the comparison.

16. The system of claim 15, wherein the attack detection circuit is configured to generate the trigger signal at a predetermined period in addition to upon detection of the adversarial attack against the first storage or the cache memory.

17. The system of claim 15, wherein the deep neural network system comprises a backup management unit configured to back up the trained neural network model to the second storage.

18. The system of claim 17, wherein the backup management unit comprises:
a sensitivity analyzer configured to analyze sensitive parameters of the trained neural network model according to bit-flip or error; and
a segregation unit configured to select for backing up sensitive parameters to the second storage according to a result of the sensitivity analyzer.

19. The system of claim 18, wherein the backup management unit includes an encryptor configured to encrypt the sensitive parameter selected in the segregation unit and provide the encrypted sensitive parameter to the second storage.

20. The system of claim 19, wherein the neural network operation unit includes at least one convolution operation core.
